(19) United States
(12) Patent Application Publication
(10) Pub. No.: US 2010/0193523 A1
(43) Pub. Date: Aug. 5, 2010

(54) Lid holder for a slow cooker appliance

(76) Inventor: Chad E. Beisheim, Omaha, NE (US)

Correspondence Address: THOMTE LAW OFFICE, L.L.C., 2120 S. 72ND STREET, SUITE 1111, OMAHA, NE, 68124, US

(21) Appl. No.: 12/322,244

(22) Filed: Jan. 30, 2009

(51) Int. Cl. A47J 36/12

(52) U.S. Cl. 220/379; 220/573.1

(57) ABSTRACT

A lid holder for a slow cooker appliance is described wherein the lid holder is mounted on the upper end of the heated housing of the appliance, with the lid holder having lid supports thereon to support the lid of the appliance when it is removed from the slow cooker.

### BACKGROUND OF THE INVENTION

1. Field of the Invention

This invention relates to a lid holder for a slow cooker appliance and more particularly to a lid holder which is attached to the slow cooker appliance for supporting the lid thereof when the lid is removed from the slow cooker.

2. Description of the Related Art

Slow cookers, such as those marked by Sunbeam Products under the registered trademark Crock Pot® comprise a heated housing, a cooking container removably positioned in the heated housing, and a lid which is selectively removably mounted on the upper end of the cooking container. As the foodstuffs in the cooking container are cooked, it is frequently necessary to remove the lid to add further ingredients thereto or to stir the cooking foodstuffs. A problem associated with all the slow cookers of which the applicant is aware is where to place the lid when it is removed from the cooker. This problem is further complicated by the fact that the underside of the lid has condensation or moisture thereon which may drain onto a stovetop, a counter top, or the like if the lid is placed thereon.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A lid holder for a slow cooker appliance is described. The lid holder of this invention is selectively removably secured to a prior art slow cooker. The prior art slow cooker normally comprises a heated housing, a cooking container removably positioned in the heated housing, and a lid which is selectively removably mounted on the upper end of the cooking container. The lid holder of this invention includes an upper end, a lower end, and opposite sides. A support member is provided at the upper end of the holder and extends upwardly therefrom. A pair of horizontally spaced-apart support members are provided at the lower end of the lid holder and have an inverted U-shaped clip positioned therebetween at the upper ends thereto. A pair of U-shaped lid supports are provided on the lid holder on the opposite sides of the lower end of the upper support member.

In use, before the cooking container is placed in the heated housing, the lid holder is secured to the upper end of the heated housing by extending the inverted U-shaped clip downwardly over the upper rim of the heated housing. The cooking container is then placed in the heated housing with the cooking container resting upon the inverted U-shaped clip. During the cooking of foodstuffs within the cooking container, the lid is positioned on the upper end thereof. When it is desired to remove the lid from the cooking container, the lid is placed on the lid holder with the spaced-apart lid support receiving and supporting the peripheral edge of the lid. Should condensation or moisture drain from the underside of the lid while it is supported by the lid holder, the moisture will drain back into the interior of the cooking container.

It is therefore a principal object of the invention to provide a lid holder for a slow cooker appliance.

A further object of the invention is to provide a lid holder for a slow cooker appliance wherein any condensation or moisture draining from the underside of the lid while it is being supported by the lid holder will drain back into the interior of the cooking container of the cooking appliance.

A further object of the invention is to provide a lid holder for a slow cooker appliance which is convenient and safe to use.

A further object of the invention is to provide a lid holder for a slow cooker which may be placed in the interior of the slow cooker when not being used.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of the lid holder of this invention;

FIG. 2 is a perspective view illustrating the lid holder mounted on a slow cooker appliance;

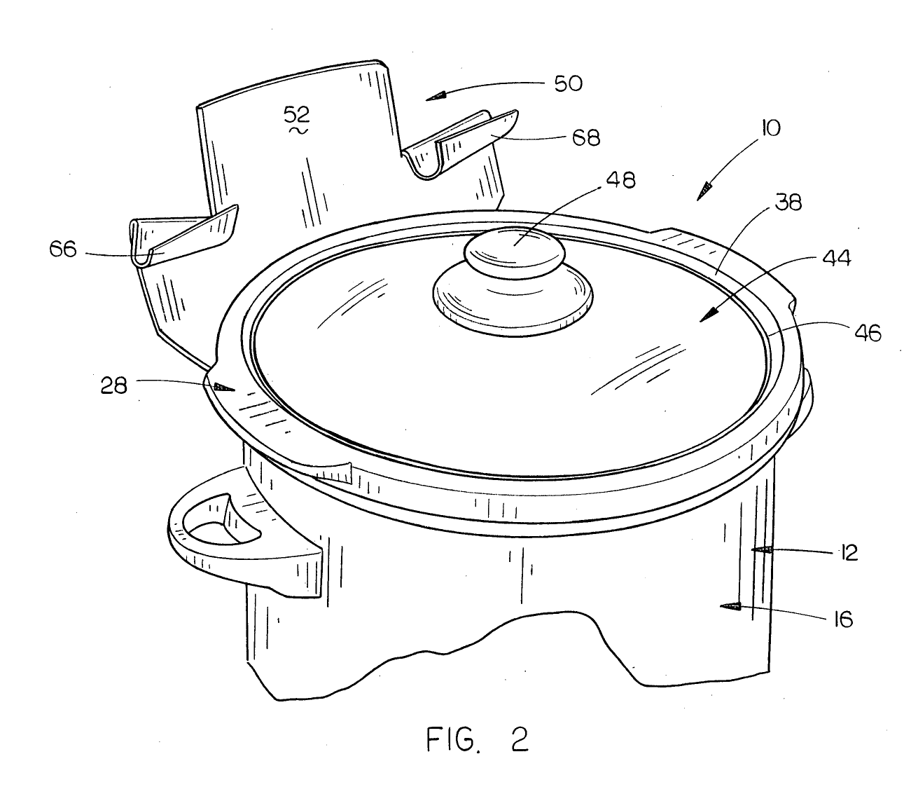

FIG. 3 is a perspective view illustrating the lid holder of this invention supporting a lid which has been removed from a slow cooker;

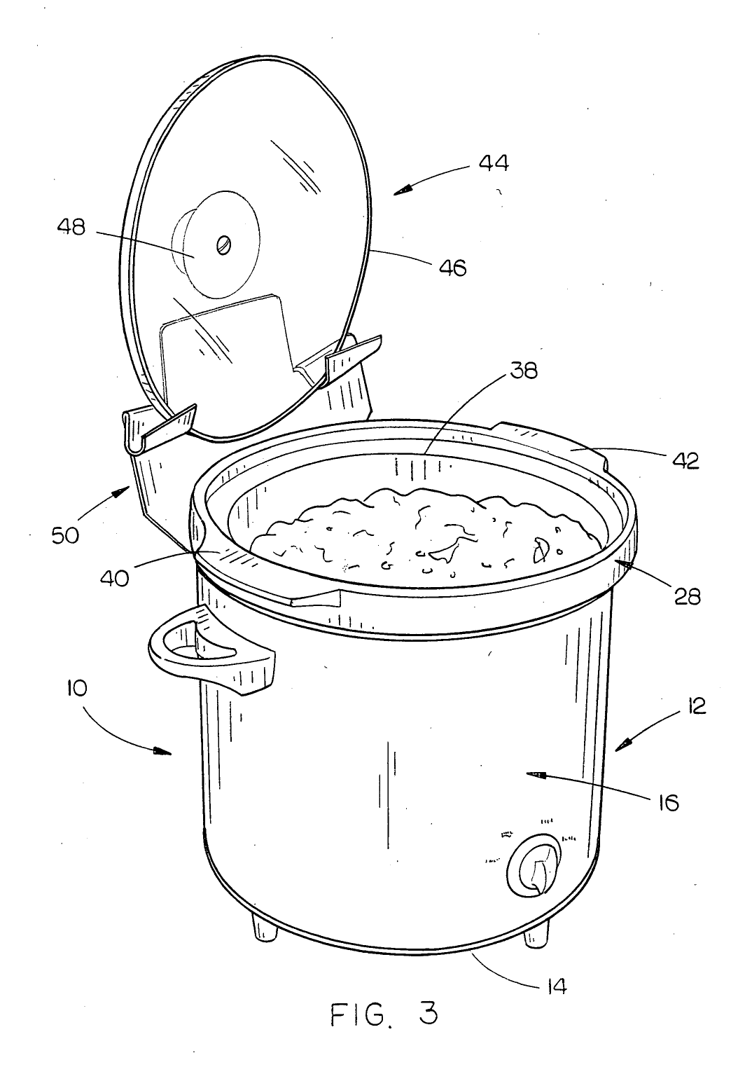

FIG. 4 is a partial sectional view illustrating the manner in which the lid holder is mounted on the slow cooker and manner in which the lid holder supports the lid; and

FIG. 5 is a perspective view illustrating the lid holder of this invention placed within the slow cooker when it is not being used.

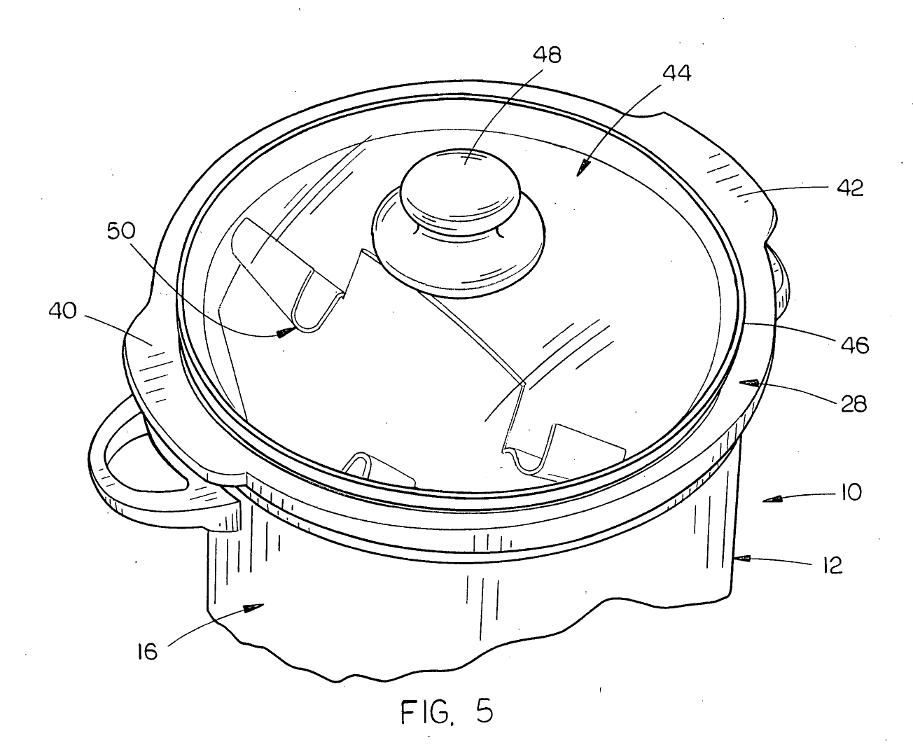

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The numeral 10 refers to a conventional slow cooker such as marketed by Sunbeam Products. Slow cooker 10 includes a housing 12 having a base or bottom 14 and a side wall 16 extending upwardly therefrom. Side wall 16 normally includes an outer side wall 18 and an inner side wall 20. A heating element is usually enclosed in the base 14 as well as between the side walls 18 and 20. Base 14 and side wall 16 define a heating cavity 22. Side wall 16 includes an upper rim 24 having an annular recess 26 formed therein.

The numeral 28 refers to a conventional cooking container having a bottom and a side wall 32 extending upwardly therefrom. Side wall 32 includes an upper rim 34 with an outwardly projecting lip 36, a lid receiving recess 38, and handles 40 and 42. Container 28 is sized and shaped so as to be received within the heating cavity 22. Housing 12 and container 28 may be cylindrical or oval in shape.

The numeral 44 refers to a lid or cover having a peripheral edge 46 and a handle or knob 48. Lid 44 is adapted to be received within the lid receiving recess 38 in conventional fashion. For purposes of description, lid 44 will be described as having an inner surface and an outer surface.

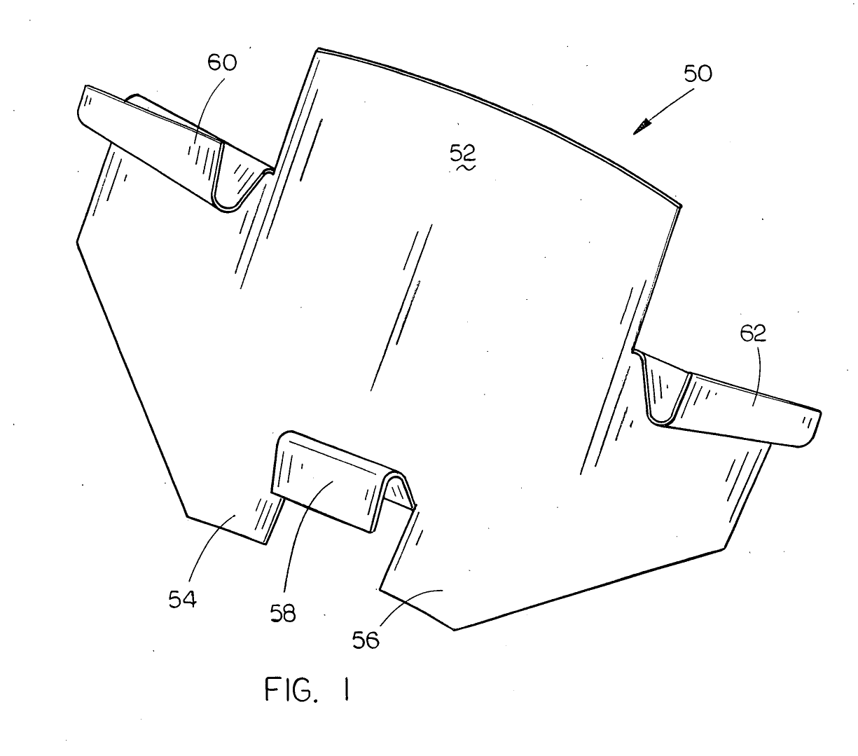

The numeral 50 refers to the lid holder of this invention. Lid holder 50 is preferably comprised of a heat resistant plastic material such as polyethylene or the like but which may also be formed from a metal material such as steel or aluminum. Preferably, lid holder 50 is of single-piece construction. Lid holder 50 includes an upper support member 52 and lower support members 54 and 56. Lid holder 50 also includes an inverted, generally U-shaped clip 58 positioned between lower support members 54 and 56 as seen in the drawings. As seen in FIG. 1, lid holder 50 also includes a pair of generally U-shaped lid supports 60 and 62 which extend outwardly and slightly upwardly from opposite sides of the lower portion of upper support member 52.

The lid holder 50 is used as follows: Prior to positioning the cooking container 28 in the heating cavity 22 of housing 12, the lid holder 50 is secured to the upper rim 24 of side wall 16 by positioning the clip 58 over the upper rim 24 with the lower support members 54 and 56 being positioned outwardly of the exterior surface of side wall 16 and being in engagement therewith. Cooking container 28 is then positioned in heating cavity 22 so that the underside of lip 36 rests upon the upper rim 24 of housing and on the upper portion of clip 58. The placement of the cooking container 28 on clip 58 serves to stabilize the lid holder to maintain it in position.

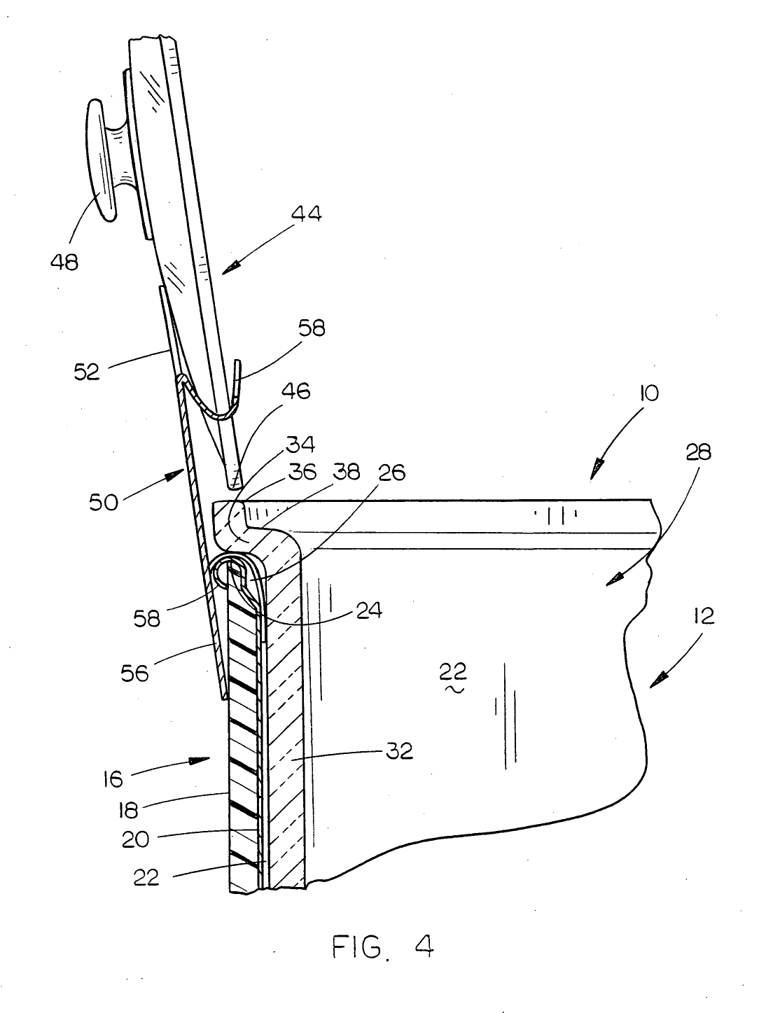

The ingredients to be cooked will then be placed in the cooking container 28 if not already positioned therein. Lid 44 is then placed over the cooking container 28 so that the peripheral edge 46 of lid 44 is received by the lid receiving recess 38. The slow cooker is then used in conventional fashion to cook the foodstuffs in cooking container 28. When the cook wishes to stir the contents in container 28, the cook grasps the handle or knob 48 of lid 44 and places the lid 44 on the lid holder 50. The lid 44 is supported by the lid holder 50 by placing the peripheral edge 46 of the lid 44 into the lid supports 66 and 68 so that the interior surface of lid 44 is facing the slow cooker. In such a position, the lid 44 is also supported by the engagement thereof with the upper support member 52. In its held position, the lower interior end of the lid 44 will be positioned slightly above the lid receiving recess 38 so that any condensation draining from the lid 44 will drain back into the interior of the cooking container 28, as seen in FIG. 4. The lid holder provides a convenient and safe means for holding the lid 44 during the times when the lid 44 is removed from the cooking container.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. In combination:
a slow cooker for heating of food stuffs;
said slow cooker including a housing having a base and a side wall extending upwardly therefrom to define a heating cavity;
said side wall of said housing having an upper rim;
a container having a hollow interior, removably positioned within said heating cavity and having a bottom and a side wall extending upwardly therefrom with the side wall of the container having an upper rim;
a lid having a peripheral edge, sized and shaped to be positioned on the rim of the side wall of the container to close the upper end of the container;
said lid having interior and exterior surfaces;
a lid holder selectively removably secured to said upper rim of said housing and extending upwardly therefrom outwardly of the slow cooker;
said lid holder including a lid support structure positioned above said upper rim of said housing and said upper rim of said container adapted to receive said peripheral edge of said lid and support said lid in an upstanding position when said lid is removed from said container.

2. The combination of claim 1 wherein said lid support structure is positioned so that the lowermost portion of the peripheral edge of the supported lid is positioned above and inwardly of said upper rim of said container so that condensation of the interior surface of said lid may drain into said container.

3. The combination of claim 1 wherein said lid support structure includes a pair of spaced lid support members.

4. The combination of claim 3 wherein each of said lid support members have a channel formed therein for receiving a portion of said peripheral edge of said lid.

5. The combination of claim 3 wherein a support member is provided on said lid holder which extends upwardly between said lid support members.

6. The combination of claim 1 wherein said lid support structure includes a lid support member which extends upwardly from said upper rim of said housing.

7. The combination of claim 1 wherein said lid holder includes an inverted clip which receives said upper rim of said housing.

8. The combination of claim 7 wherein said lid holder includes a support member which extends downwardly from said clip for engagement with the outer surface of said housing.

9. The combination of claim 1 wherein said lid holder includes a support member which engages the outer surface of said housing.

10. The combination of claim 7 wherein a portion of said upper rim of said container rests upon said clip to maintain said clip on said upper rim of said housing.

11. A lid holder for a slow cooker including a housing having a base and a side wall extending upwardly therefrom to define a heating cavity; said side wall of said housing having an upper rim; a container having a hollow interior, removably positioned within said heating cavity and having a bottom and a side wall extending upwardly therefrom with the side wall of the container having an upper rim; a lid having a peripheral edge, sized and shaped to be positioned on the rim of the side wall of the container to close the upper end of the container; said lid having interior and exterior surfaces;
a lid holder selectively removably secured to said upper rim of said housing and extending upwardly therefrom outwardly of the slow cooker;
said lid holder including a lid support structure positioned above said upper rim of said housing and said upper rim of said container adapted to receive said peripheral edge of said lid and support said lid in an upstanding position when said lid is removed from said container.

12. The lid holder of claim 11 wherein said lid support structure is positioned so that the lowermost portion of the peripheral edge of the supported lid is positioned above and inwardly of said upper rim of said container so that condensation of the interior surface of said lid may drain into said container.

13. The lid holder of claim 11 wherein said lid support structure includes a pair of spaced lid support members.

14. The lid holder of claim 13 wherein each of said lid support members have a channel formed therein for receiving a portion of said peripheral edge of said lid.

15. The lid holder of claim 13 wherein a support member is provided on said lid holder which extends upwardly between said lid support members.

16. The lid holder of claim 11 wherein said lid support structure includes a lid support member which extends upwardly from said upper rim of said housing.

17. The lid holder of claim 11 wherein said lid holder includes an inverted clip which receives said upper rim of said housing.

18. The lid holder of claim 17 wherein said lid holder includes a support member which extends downwardly from said clip for engagement with the outer surface of said housing.

19. The lid holder of claim 11 wherein said lid holder includes a support member which engages the outer surface of said housing.

20. The lid holder of claim 17 wherein a portion of said upper rim of said container rests upon said clip to maintain said clip on said upper rim of said housing
